(19) United States
(12) Patent Application Publication
(10) Pub. No.: US 2010/0070658 A1
(43) Pub. Date: Mar. 18, 2010

(54) METHOD OF COMMUNICATION BETWEEN A PROTOCOL-PROCESSING UNIT AND AN INPUT/OUTPUT (I/O) DEVICE THROUGH A DEVICE INTERFACE CONTROLLER

(75) Inventors: Hung-Chih Chiang, Kaohsiung City (TW); Ming-Feng Wu, Tainan City (TW); Shih-Ching Hsiao, Kaohsiung City (TW); Chi-Cheng Cheng, Kaohsiung County (TW); Yau-Wen Liu, Kaohsiung City (TW); Chang-Ming Tsai, Kaohsiung County (TW)

Correspondence Address: BAKER & DANIELS LLP;111 E. WAYNE STREET, SUITE 800, FORT WAYNE, IN, 46802, US

(73) Assignee: ETREND ELECTRONICS, INC., Kaohsiung City (TW)

(21) Appl. No.: 12/555,869

(22) Filed: Sep. 9, 2009

(30) Foreign Application Priority Data
Sep. 12, 2008 (TW) 097135096
Nov. 21, 2008 (TW) 097145141

(51) Int. Cl. G06F 3/00

(52) U.S. Cl. 710/13

(57) ABSTRACT

A method of communication between a protocol-processing unit and an input/output (I/O) device through a device interface controller includes configuring the protocol-processing unit to write command/message data in a predefined write file, and configuring the device interface controller to translate the command/message data written in the predefined write file into a corresponding command/message and to transmit the corresponding command/message thus translated to the I/O device. A system that includes the protocol-processing unit and the device interface controller is also disclosed.

### CROSS-REFERENCE TO RELATED APPLICATION

This application claims priority of Taiwanese Application No. 097135096, filed on Sep. 12, 2008, and Taiwanese Application No. 097145141, filed on Nov. 21, 2008.

### BACKGROUND OF THE INVENTION

1. Field of the Invention

This invention relates to a method of communication, more particularly to a method of communication between a protocol-processing unit and an input/output (I/O) device through a device interface controller.

2. Description of the Related Art

A memory card, such as a secure digital (SD) memory card, a multi-media card (MMC) memory card, a memory stick (MS) memory card, or a MS micro (M2) memory card, which incorporates an input/output (I/O) device, such as a Bluetooth device, a Wi-Fi device, or a global positioning system (GPS) device, is well known in the art.

When connected to a protocol-processing unit, a flash memory of the conventional memory card is accessible, i.e., capable of being read and written, by the protocol-processing unit using a file-accessing function that resides in an operating system, such as Microsoft Windows®, installed in the protocol-processing unit.

The aforementioned conventional memory card is disadvantageous in that a driver for the I/O device thereof has to be installed in the protocol-processing unit in order to allow communication between the protocol-processing unit and the I/O device, and since I/O device drivers are operating system-specific, the manufacturer of the conventional memory card has to develop different drivers for the I/O device. This causes inconvenience on the part of the manufacturer and incurs high manufacturing costs.

### SUMMARY OF THE INVENTION

Therefore, the main object of the present invention is to provide a method of communication between a protocol-processing unit and an input/output (I/O) device through a device interface controller that eliminates the need to install a driver for the I/O device in the protocol-processing unit.

According to an aspect of the present invention, a method of communication between a protocol-processing unit and an input/output (I/O) device through a device interface controller comprises configuring the protocol-processing unit to write command/message data in a predefined write file, and configuring the device interface controller to translate the command/message data written in the predefined write file into a corresponding command/message and to transmit the corresponding command/message thus translated to the I/O device.

According to another aspect of the present invention, a system comprises a protocol-processing unit and a device interface controller. The device interface controller is coupled to the protocol-processing unit and is adapted to be coupled to an I/O device. The protocol-processing unit is operable so as to write command/message data in a predefined write file. The device interface controller is operable so as to translate the command/message data written in the predefined write file into a corresponding command/message and so as to transmit the corresponding command/message thus translated to the I/O device.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of the preferred embodiment of a system according to this invention; and

FIGS. 2 and 3 are flow charts of the preferred embodiment of a method of communication between a protocol-processing unit of the system and an input/output (I/O) device through a device interface controller of the system according to this invention.

### DETAILED DESCRIPTION OF THE PREFERRED EMBODIMENT

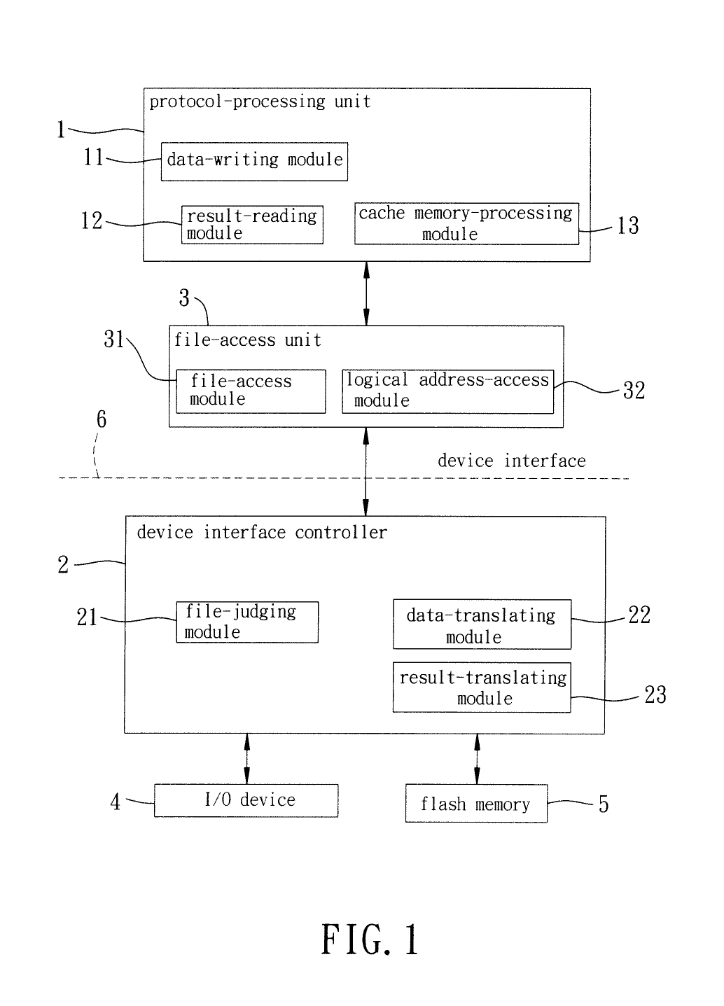

Referring to FIG. 1, the preferred embodiment of a system according to this invention is shown to include a protocol-processing unit 1 and a device interface controller 2.

The protocol-processing unit 1 includes a data-writing module 11, a result-reading module 12, and a cache memory-processing module 13. In this embodiment, the protocol-processing unit 1 is an application program installed in an operating system, such as Microsoft Windows, Linux, Microsoft Windows CE, or Symbian.

The device interface controller 2 connects an input/output (I/O) device 4 to the protocol-processing unit 1, and includes a file-judging module 21, a data-translating module 22, and a result-translating module 23.

The system further includes a flash memory 5 and a device interface 6.

The flash memory 5 is connected to the device interface controller 2. In this embodiment, the device interface controller 2, the I/O device 4, and the flash memory 5 constitute a memory card. Preferably, the device interface controller 2, the I/O device 4, and the flash memory 5 constitute a secure digital (SD) memory card, such as a mini-SD or a micro-SD memory card, a multi-media card (MMC) memory card, such as an RS-MMC or a micro-MMC memory card, a memory stick (MS) memory card, such as an MS Duo/Pro memory card, or a MS micro (M2) memory card.

The device interface 6 via which the device interface controller 2 is connected to the protocol-processing unit 1 complies with a standard established for small form memory card interface. Preferably, the device interface 6 is an SD memory card-compliant interface, an MMC memory card-compliant interface, an MS memory card-compliant interface, or an M2 memory card-compliant interface.

The data-writing module 11 of the protocol-processing unit 1 is operable so as to write command/message data in a predefined write file. In this embodiment, the data-writing module 11 of the protocol-processing unit 1 interacts with, i.e., writes the command/message data in the predefined write file of, the device interface controller 2 through a file-access unit 3.

In this embodiment, when the protocol-processing unit 1 is in a filename access mode, the data-writing module 11 thereof, through a file-access module 31 of the file-access unit 3, writes the command/message data in the predefined write file with reference to a filename of the predefined write file. On the other hand, when the protocol-processing unit 1 is in a logical address access mode, the data-writing module 11 thereof, through a logical address-access module 32 of the file-access unit 3, analyzes an architecture of a file format, determines a logical address of the predefined write file, and writes the command/message data in the predefined write file with reference to the logical address of the predefined write file determined thereby.

It is noted that the file-access unit 3 is a function for accessing files and resides in the operating system.

Furthermore, at least one of the file-access module 31 and the logical address-access module 32 of the file-access unit 3 is written in C/C++ or JAVA, such as JAVA 2 platform standard edition (J2SE), JAVA 2 platform Micro Edition (J2ME), or JAVA 2 platform Enterprise Edition (J2EE).

The cache memory-processing module 13 of the protocol-processing unit 1 is operable so as to transfer the command/message data written in the predefined write file immediately to the device interface controller 2. A cache memory (not shown) in the operating system stores the command/message data temporarily but does not transfer the command/message data immediately to the device interface controller 2. The cache memory-processing module 13 of the protocol-processing unit 1 transfers the command/message data immediately from the cache memory in the operating system to the device interface controller 2.

The cache memory-processing module 13 of the protocol-processing unit 1 is further operable so as to disable the cache memory in the operating system prior to writing of the command/message data by the data-writing module 11 of the protocol-processing unit 1 in the predefined write file to thereby transfer the command/message data directly to the device interface controller 2.

The file-judging module 21 of the device interface controller 2 is operable so as to determine whether the command/message data is written in the predefined write file.

The data-translating module 22 of the device interface controller 2 is operable so as to translate the command/message data written in the predefined write file into a corresponding command/message and so as to transmit the corresponding command/message thus translated to the I/O device 4 when the file-judging module 21 of the device interface controller 2 determines that the command/message data is written in the predefined write file.

The result-translating module 23 of the device interface controller 2 is operable so as to receive a result from the I/O device 4. In this embodiment, the result-translating module 23 translates the result into response data and transmits the response data thus translated to the protocol-processing unit 1 when the file-judging module 21 of the device interface controller 2 determines that the response data is read from a predefined read file.

The result-reading module 12 of the protocol-processing unit 1 is operable so as to read the response data from the predefined read file. In this embodiment, the result-reading module 12 of the protocol-processing unit 1 interacts with, i.e., reads the response data from the predefined read file of, the device interface controller 2 through the file-access unit 3.

In this embodiment, when the protocol-processing unit 1 is in the filename access mode, the result-reading module 12 thereof, through the file-access module 31 of the file-access unit 3, reads the response data from the predefined read file with reference to the filename of the predefined read file. On the other hand, when the protocol-processing unit 1 is in the logical address access mode, the result-reading module 12 thereof, through the logical address-access module 32 of the file-access unit 3, analyzes an architecture of a file format, determines a logical address of the predefined read file, and reads the response data from the predefined read file with reference to the logical address of the predefined read file determined thereby.

The cache memory-processing module 13 of the protocol-processing unit 1 is further operable so as to transmit the response data immediately from the device interface controller 2. The protocol-processing unit 1 transmits data from the cache memory in the operating system when the data are previously stored in the cache memory in the operating system. The cache memory-processing module 13 of the protocol-processing unit 1 transmits the response data immediately from the device interface controller 2 and not from the cache memory in the operating system.

The cache memory-processing module 13 of the protocol-processing unit 1 is further operable so as to disable the cache memory in the operating system prior to reading of the response data by the result-reading module 12 of the protocol-processing unit 1 from the predefined read file. As such, the response data is read directly from the device interface controller 2.

It is noted that the predefined read and write files may be the same file or different files.

Furthermore, while writing of the command/message data in the predefined write file and reading of the response data from the predefined read file are accomplished by the protocol-processing unit 1 through the device interface controller 2 in this embodiment, the invention is not limited in this respect since other configurations that enable the protocol-processing unit 1 to write in the predefined write file and to read from the predefined read file can be readily appreciated by those skilled in the art.

In an alternative embodiment, the device interface controller 2 serves as a virtual memory (not shown) with a file format architecture, which includes the predefined read and write files, when there is no flash memory connected to thereto, and the device interface controller 2 and the I/O device 4 constitute a virtual memory card.

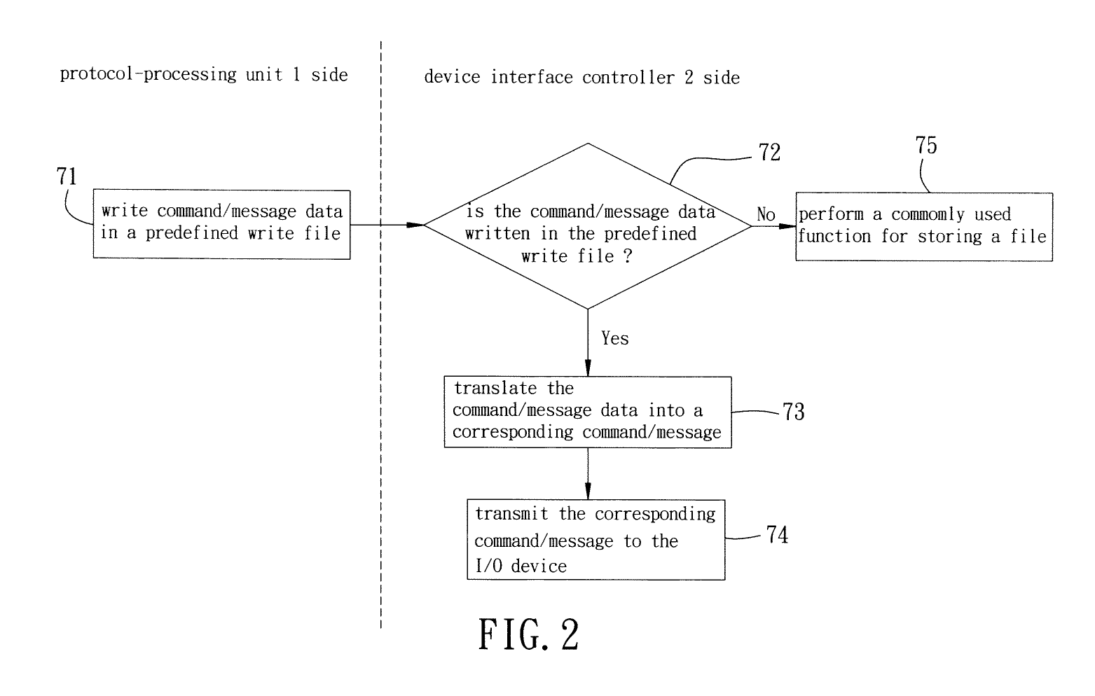

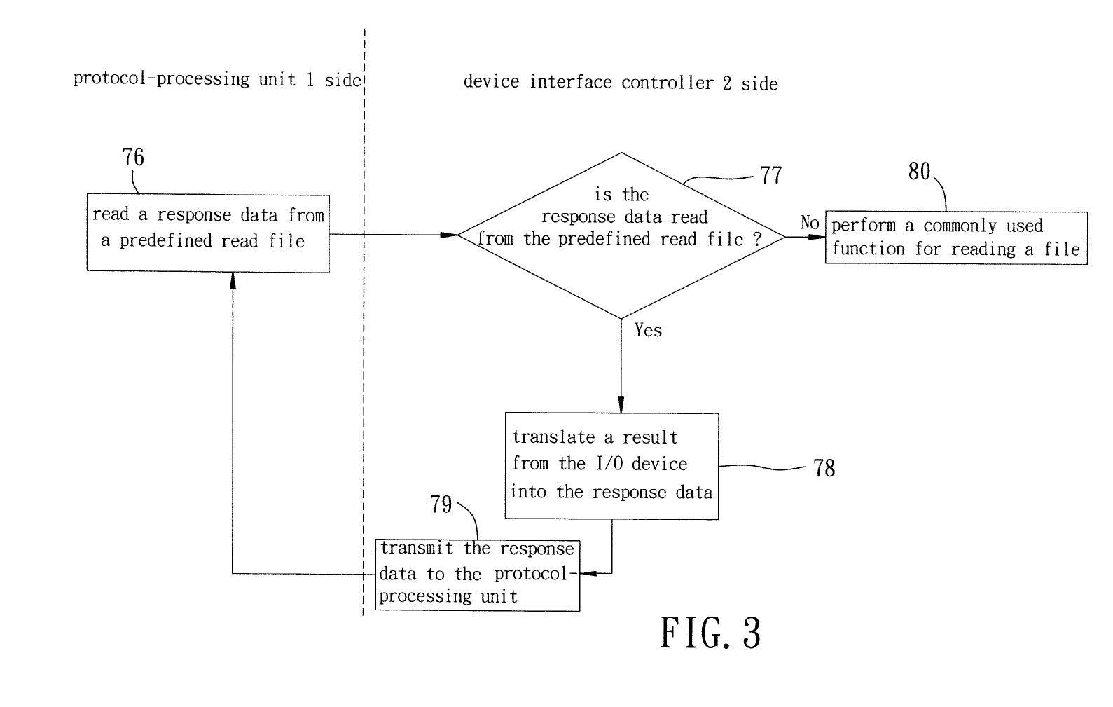

The preferred embodiment of a method of communication between the protocol-processing unit 1 and the input/output (I/O) device 4 through the device interface controller 2 according to this invention will now be described with further reference to FIGS. 2 and 3.

In step 71, the data-writing module 11 of the protocol-processing unit 1 writes command/message data in the predefined write file.

In step 72, when the file-judging module 21 of the device interface controller 2 determines that the command/message data is written in the predefined write file, the flow proceeds to step 73. Otherwise, the flow proceeds to step 75.

In step 73, the data-translating module 21 of the device interface controller 2 translates the command/message data into a corresponding command/message.

In step 74, the data-translating module 21 of the device interface controller 2 transmits the corresponding command/message thus translated to the I/O device 4. Thereafter, the flow is terminated.

In step 75, the data-writing module 11 of the protocol-processing unit 1 performs a commonly used function for storing a file. Thereafter, the flow is terminated.

In step 76, the result-reading module 12 of the protocol-processing unit 1 reads a response data from the predefined read file.

In step 77, when the file-judging module 21 of the device interface controller 2 determines that the response data is read from the predefined read file, the flow proceeds to step 78. Otherwise, the flow proceeds to step 80.

In step 78, the result-translating module 22 of the device interface controller 2 translates a result from the I/O device 4 into the response data.

In step 79, the result-translating module 22 of the device interface controller 2 transmits the response data thus translated to the protocol-processing unit 1. Thereafter, the flow goes back to step 76 until the protocol-processing unit 1 reads all of the response data.

In step 80, the result-reading module 12 of the protocol-processing unit 1 performs a commonly used function for reading a file. Thereafter, the flow is terminated.

In an alternative embodiment, the method further includes the step of configuring the cache memory-processing module 13 of the protocol-processing unit 1 to disable the cache memory in the operating system prior to step 71. As such, in step 71, the command/message data is transmitted directly to the device interface controller 2.

The method further includes the step of configuring the cache memory-processing module 13 of the protocol-processing unit 1 to transfer the command/message data to be written in step 71 from the cache memory in the operating system immediately to the device interface controller 2. For instance, when the operating system is a Symbian, the cache memory-processing module 13 of the protocol-processing unit 1 may use a predefined function, i.e., a flush function, residing in the operating system to transfer the command/message data from the cache memory in the operating system immediately to the device interface controller 2.

The method further includes the step of configuring the cache memory-processing module 13 of the protocol-processing unit 1 to disable the cache memory in the operating system prior to step 76. As such, in step 76, the response data is transmitted directly from the device interface controller 2.

In an alternative embodiment, the method further includes the step of configuring the cache memory-processing module 13 of the protocol-processing unit 1 to read data, the size of which is larger than that of the cache memory in the operating system. As such, in step 76, the result-reading module 12 of the protocol-processing unit 1 reads the response data from the device interface controller 2 and not from the cache memory in the operating system.

In yet another embodiment, the method further includes the step of configuring the cache memory-processing module 13 of the protocol-processing unit 1 to read offset sectors of the predefined read file in one of incrementing and decrementing manner. As such, in step 76, the result-reading module 12 of the protocol-processing unit 1 reads the response data immediately from the device interface controller 2 and not from the cache memory in the operating system.

In still another embodiment, the method further includes the step of configuring the cache memory-processing module 13 of the protocol-processing unit 1 to read data from the predefined read file in an accumulative manner. As such, in step 76, the result-reading module 12 of the protocol-processing unit 1 reads the response data immediately from the device interface controller 2 and not from the cache memory in the operating system.

In sum, since communication between the protocol-processing unit 1 and the I/O device 4 is conducted indirectly through the device interface controller 2, there is no need to install operating system-specific drivers in the protocol-processing unit 1, thereby alleviating the drawbacks commonly encountered in the prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method of communication between a protocol-processing unit and an input/output (I/o) device through a device interface controller, said method comprising:
A) configuring the protocol-processing unit to write command/message data in a predefined write file; and
B) configuring the device interface controller to translate the command/message data written in the predefined write file into a corresponding command/message and to transmit the corresponding command/message thus translated to the I/O device.

2. The method as claimed in claim 1, further comprising:
C) configuring the protocol-processing unit to transfer the command/message data written in step A) from a cache memory to the device interface controller prior to step B).

3. The method as claimed in claim 1, further comprising:
C) configuring the protocol-processing unit to disable a cache memory prior to step A).

4. The method as claimed in claim 1, wherein step B) is performed only when, in step A), the command/message data is written in the predefined write file.

5. The method as claimed in claim 1, wherein step A) is performed in one of a filename access mode, where the command/message data is written in the predefined write file with reference to a filename of the predefined write file, and a logical address access mode, where the command/message data is written in the predefined write file with reference to a logical address of the predefined write file.

6. The method as claimed in claim 1, further comprising:
C) configuring the device interface controller to receive a result from the I/O device;
D) configuring the protocol-processing unit to read a response data from a predefined read file; and
E) configuring the device interface controller to translate the result into the response data, and to transmit the response data thus translated to the protocol-processing unit.

7. The method as claimed in claim 6, wherein step E) is performed only when, in step D), the response data is read from the predefined read file.

8. The method as claimed in claim 6, further comprising:
F) configuring the protocol-processing unit to disable a cache memory prior to step D).

9. The method as claimed in claim 6, wherein the protocol-processing unit is configured to read data, the size of which is larger than that of a cache memory, prior to step D), thereby permitting the protocol-processing unit to read the response data from the device interface controller and not from the cache memory.

10. The method as claimed in claim 6, wherein the protocol-processing unit is configured to read a plurality of offset sectors of the predefined read file prior to step D), thereby permitting the protocol-processing unit to read the response data from the device interface controller and not from a cache memory.

11. The method as claimed in claim 10, wherein the protocol-processing unit is configured to read the offset sectors of the predefined read file in one of an incrementing manner and a decrementing manner.

12. The method as claimed in claim 6, wherein the protocol-processing unit is configured to read data in an accumulative manner prior to step D), thereby permitting the protocol-processing unit to read the response data from the device interface controller and not from a cache memory.

13. The method as claimed in claim 6, wherein step D) is performed in one of a filename access mode, where the response data is read from the predefined read file with reference to a filename of the predefined read file, and a logical address access mode, where the response data is read from the predefined read file with reference to a logical address of the predefined read file.

14. The method as claimed in claim 6, wherein the predefined write and read files are the same file.

15. The method as claimed in claim 6, wherein the predefined write and read files are different files.

16. The method as claimed in claim 6, further comprising:
F) configuring the device interface controller to serve as a virtual memory with a file format architecture, which includes the predefined read and write files, when there is no flash memory connected thereto.

17. The method as claimed in claim 1, wherein the device interface controller is connected to the protocol-processing unit via a device interface that complies with a standard established for small form memory card interface.

18. The method as claimed in claim 17, wherein the device interface is one of a secure digital (SD) memory card compliant interface, a multimedia card (MMC) memory card compliant interface, a memory stick (MS) memory card compliant interface, and a MS micro (M2) memory card compliant interface.

19. A system, comprising:
a protocol-processing unit; and
a device interface controller coupled to said protocol-processing unit and adapted to be coupled to an I/O device,
wherein said protocol-processing unit is operable so as to write command/message data in a predefined write file, and
wherein said device interface controller is operable so as to translate the command/message data written in the predefined write file into a corresponding command/message and so as to transmit the corresponding command/message thus translated to the I/O device.

20. The system as claimed in claim 19, wherein said protocol-processing unit is further operable so as to transfer the command/message data written in the predefined write file from a cache memory to said device interface controller.

21. The system as claimed in claim 19, wherein said protocol-processing unit is further operable so as to disable a cache memory prior to writing of the command/message data thereby in the predefined write file.

22. The system as claimed in claim 19, wherein said device interface controller is further operable so as to determine whether the command/message data is written in the predefined write file,
said device interface controller translating the command/message data into the corresponding command/message and transmitting the corresponding command/message to the I/O device only when it is determined thereby that the command/message data is written in the predefined write file.

23. The system as claimed in claim 19, wherein said protocol-processing unit is operable in one of a filename access mode, where said protocol-processing unit writes the command/message data in the predefined write file with reference to a filename of the predefined write 2 0 file, and a logical address access mode, where said protocol-processing unit writes the command/message data in the predefined write file with reference to a logical address of the predefined write file.

24. The system as claimed in claim 19, wherein said device interface controller is further operable so as to receive a result from the I/O device, so as to translate the result into response data, and so as to transmit the response data thus translated to said protocol-processing unit.

25. The system as claimed in claim 24, wherein said protocol-processing unit is further operable so as to read the response data from a predefined read file.

26. The system as claimed in claim 25, wherein said device interface controller is further operable so as to determine whether the response data is read from the predefined read file,
said device interface controller translating the result into the response data and transmitting the response data to said protocol-processing unit only when it is determined thereby that the response data is read from the predefined read file.

27. The system as claimed in claim 25, wherein said protocol-processing unit reads data, the size of which is larger than that of a cache memory, thereby permitting said protocol-processing unit to read the response data from said device interface controller and not from the cache memory.

28. The system as claimed in claim 25, wherein said protocol-processing unit reads a plurality of offset sectors of the predefined read file, thereby permitting said protocol-processing unit to read the response data from said device interface controller and not from a cache memory.

29. The system as claimed in claim 28, wherein said protocol-processing unit reads the offset sectors of the predefined read file in one of an incrementing manner and a decrementing manner.

30. The system as claimed in claim 25, wherein said protocol-processing unit reads data in an accumulative manner, thereby permitting said protocol-processing unit to read the response data from said device interface controller and not from a cache memory.

31. The system as claimed in claim 25, wherein said protocol-processing unit is operable in one of a filename access mode, where said protocol-processing unit reads the response data from the predefined read file with reference to a filename of the predefined read file, and a logical address access mode, where said protocol-processing unit reads the response data from the predefined read file with reference to a logical address of the predefined read file.

32. The system as claimed in claim 25, wherein the predefined write and read files are the same file.

33. The system as claimed in claim 25, wherein the predefined write and read files are different files.

34. The system as claimed in claim 25, wherein said device interface controller serves as a virtual memory with a file format architecture, which includes the predefined read and write files, when there is no flash memory connected thereto, and said device interface controller and the I/O device constitute a virtual memory card.

35. The system as claimed in claim 19, further comprising a flash memory coupled to said device interface controller, wherein said device interface controller, the I/O device, and said flash memory constitute a memory card.

36. The system as claimed in claim 19, wherein said device interface controller is connected to said protocol-processing unit via a device interface that complies with a standard established for small form memory card interface.

37. The system as claimed in claim 36, wherein said device interface is one of a secure digital (SD) memory card compliant interface, a multimedia card (MMC) memory card compliant interface, a memory stick (MS) memory card compliant interface, and an MS micro (M2) memory card compliant interface.
